(19) United States
(12) Patent Application Publication
(10) Pub. No.: US 2025/0191167 A1
(43) Pub. Date: Jun. 12, 2025

(54) INSPECTION DEVICE AND INSPECTION METHOD

(71) Applicant: NHK SPRING CO., LTD., Yokohama-shi (JP)

(72) Inventor: Hiroyoshi UETAKE, Yokohama-shi (JP)

(73) Assignee: NHK SPRING CO., LTD., Yokohama-shi (JP)

(21) Appl. No.: 18/969,387

(22) Filed: Dec. 5, 2024

(30) Foreign Application Priority Data
Dec. 8, 2023 (JP) 2023-207838

(51) Int. Cl. G06T 7/00; G06T 7/60; H04N 23/56

(52) U.S. Cl. CPC G06T 7/0004; G06T 7/60; H04N 23/56; G06T 2207/30164

(57) ABSTRACT

According to an embodiment, an inspection device inspects a target object including a hole and a component inserted into the hole. The inspection device includes a plurality of light sources configured to illuminate an area including the hole in different directions in series, a camera configured to generate a plurality of digital images of the area illuminated by the light sources in series, and a controller configured to determine whether the component is normally inserted into the hole based on a shadow included in each of the digital images generated by the camera.

### CROSS-REFERENCE TO RELATED APPLICATIONS

This application is based upon and claims the benefit of priority from prior Japanese Patent Application No. 2023-207838, filed Dec. 8, 2023, the entire contents of which are incorporated herein by reference.

### BACKGROUND OF THE INVENTION

### 1. Field of the Invention

The present invention relates to an inspection device and an inspection method for performing an inspection for the attachment of components.

### 2. Description of the Related Art

When the attachment of a component is performed in the manufacturing process of a product or the like, an inspection for confirming whether or not the attachment has been normally performed may be carried out. For this inspection, for example, digital images obtained by capturing the target object by a camera are used.

### BRIEF SUMMARY OF THE INVENTION

In the above conventional inspection using digital images, it is difficult to accurately determine whether the attachment is good or bad depending on the shape or position of the target object of the inspection. In consideration of this problem, one of the objects of the present invention is to improve the accuracy of the inspection of the target object including an attached component.

According to an embodiment, an inspection device inspects a target object including a hole and a component inserted into the hole. The inspection device comprises a plurality of light sources configured to illuminate an area including the hole in different directions in series, a camera configured to generate a plurality of digital images of the area illuminated by the light sources in series, and a controller configured to determine whether the component is normally inserted into the hole based on a shadow included in each of the digital images generated by the camera.

According to another aspect of the embodiment, an inspection method is used to inspect a target object including a hole and a component inserted into the hole. The method includes illuminating an area including the hole by a plurality of light sources in different directions in series, generating a plurality of digital images of the area illuminated by the light sources in series by a camera, and determining whether the component is normally inserted into the hole based on a shadow included in each of the digital images generated by the camera.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a schematic configuration of an inspection device according to an embodiment.

FIG. 2 is a schematic plan view showing the relationship between the target object and light sources.

FIG. 3 is a schematic cross-sectional view showing the relationship between the target object and the illumination directions of light sources.

FIG. 4 is a schematic cross-sectional view showing the relationship between the target object and the illumination directions of the other light sources.

FIG. 5 is a schematic cross-sectional view showing an example of abnormal attachment in the target object.

FIG. 6 is a flowchart showing an example of the attachment of components to a base member provided in the target object and an inspection performed after this attachment.

FIG. 7 is a diagram showing an example of a digital image generated in step S2 of the flowchart of FIG. 6.

FIG. 8 is a diagram showing an example of a digital image generated in step S5 of the flowchart of FIG. 6.

FIG. 9 is a diagram showing an example of a digital image generated in step S6 of the flowchart of FIG. 6.

FIG. 10 is a diagram showing an example of a digital image generated in step S7 of the flowchart of FIG. 6.

FIG. 11 is a diagram showing an example of a digital image generated in step S8 of the flowchart of FIG. 6.

FIG. 12 is a schematic plan view showing a modified example of the relationships between the light sources and a plurality of holes.

### DETAILED DESCRIPTION OF THE INVENTION

Embodiments will be described with reference to the accompanying drawings.

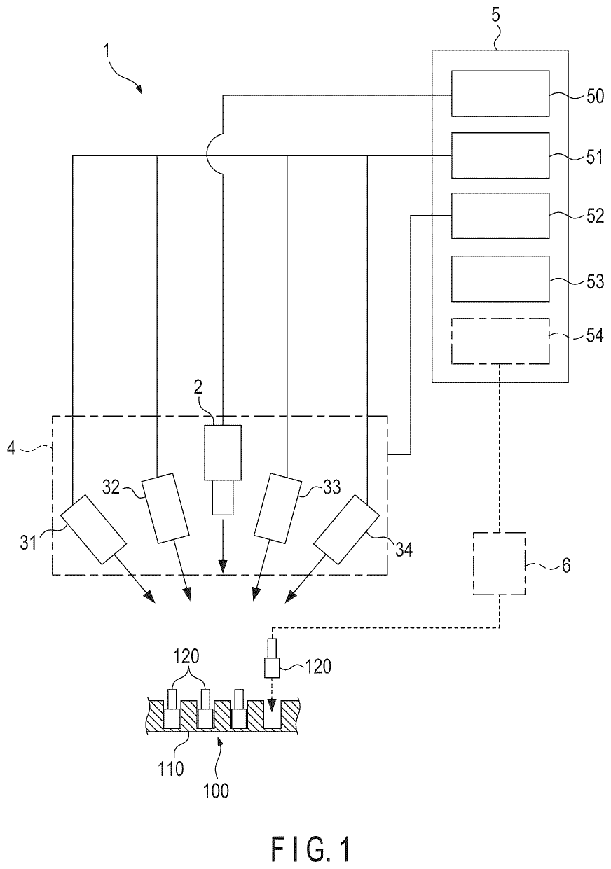

FIG. 1 is a block diagram showing a schematic configuration of an inspection device 1 according to an embodiment. The inspection device 1 performs an inspection for a target object 100. The target object 100 comprises a base member 110 and components 120 attached to this base member 110.

The inspection device 1 comprises a camera 2 which captures the target object 100, light sources 31 to 34 which illuminate the target object 100, a movement mechanism 4 and a controller 5. It should be noted that the number of light sources provided in the inspection device 1 is not necessarily limited to the four light sources 31 to 34 and may be two or more.

The movement mechanism 4 relatively moves the camera 2 and the target object 100. This embodiment assumes a case where the movement mechanism 4 moves the camera 2 and the light sources 31 to 34 relative to the target object 100 provided at the inspection position. As another example, the movement mechanism 4 may move the target object 100 relative to the fixed camera 2 and light sources 31 to 34.

The controller 5 comprises a camera control module 50 which controls the camera 2, a light source control module 51 which controls the light sources 31 to 34, a movement control module 52 which controls the movement mechanism 4, and an analysis module 53 which analyzes digital images (image data) generated by the camera 2. For example, the camera control module 50, the light source control module 51, the movement control module 52 and the analysis module 53 are software modules which are realized when a processor runs a computer program. The camera control module 50, the light source control module 51, the movement control module 52 and the analysis module 53 may be realized by different processors and computer programs. At least one of the camera control module 50, the light source control module 51, the movement control module 52 and the analysis module 53 may be realized by a hardware module or cooperation between a software module and a hardware module.

The inspection device 1 may further comprise an attachment device 6 for attaching the components 120 to the base member 110 of the target object 100. In this case, the controller 5 may further comprise an attachment control module 54 which controls the attachment device 6. It should be noted that the attachment device 6 and the attachment control module 54 may be part of the manufacturing device including the inspection device 1.

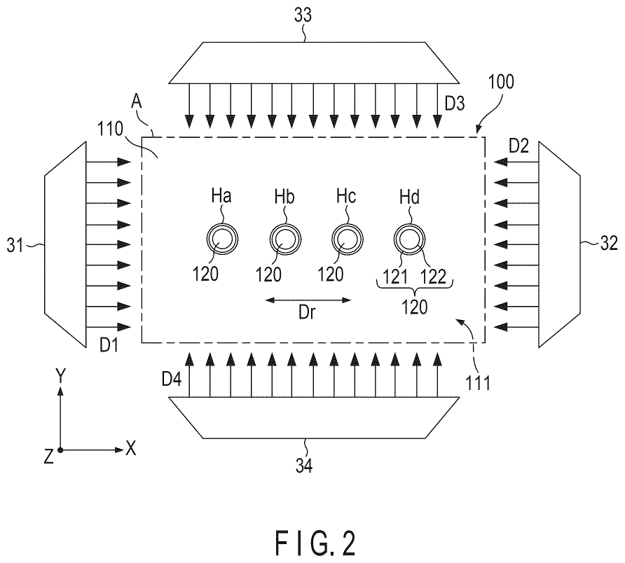

FIG. 2 is a schematic plan view showing the relationship between the target object 100 and the light sources 31 to 34. The base member 110 of the target object 100 has, for example, an attachment face 111 which is flat, and a plurality of holes H (Ha, Hb, Hc and Hd) provided in this attachment face 111. The light sources 31 to 34 illuminate at least the area A shown by the rectangular frame of chain lines in the figure. The area A includes the holes Ha, Hb, Hc and Hd.

Here, an X-direction, a Y-direction and a Z-direction orthogonal to each other are defined as shown in FIG. 2. Both the X-direction and the Y-direction are parallel to the attachment face 111. The Z-direction is orthogonal to the attachment face 111. In the following explanation, when the target object 100 is viewed parallel to the Z-direction, the appearance is referred to as a plan view.

All of the holes Ha, Hb, Hc and Hd are circular as seen in plan view. The holes Ha, Hb, Hc and Hd are arranged in an array direction Dr. In the example of FIG. 2, the array direction Dr is parallel to the X-direction. The components 120 are inserted into the holes Ha, Hb, Hc and Hd, respectively.

The light source 31 emits light in illumination direction D1. The light source 32 emits light in illumination direction D2. The light source 33 emits light in illumination direction D3. The light source 34 emits light in illumination direction D4. Illumination directions D1 to D4 are directions which are different from each other. When the target object 100 is viewed in plan view as in the case of FIG. 2, illumination directions D1 and D2 are parallel to the X-direction and are opposite directions. Further, when the target object 100 is viewed in plan view as in the case of FIG. 2, illumination directions D3 and D4 are parallel to the Y-direction and are opposite directions.

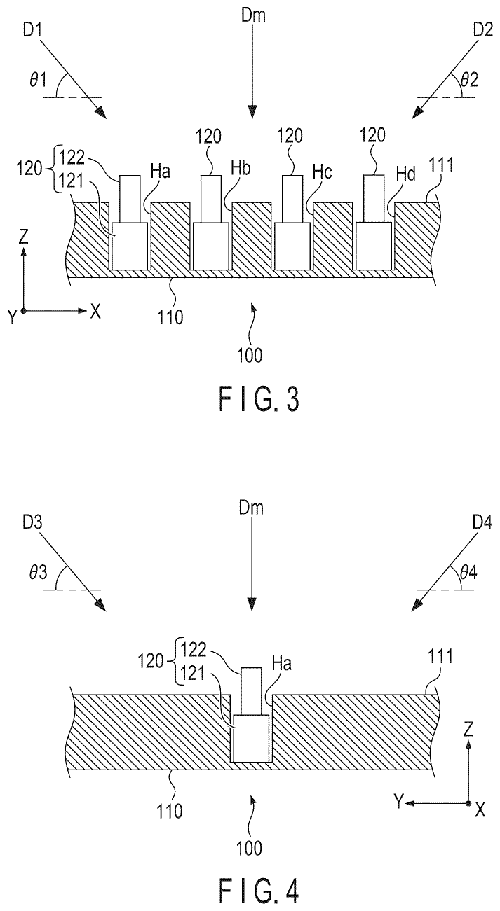

FIG. 3 is a schematic cross-sectional view showing the relationship between the target object 100 and illumination directions D1 and D2. FIG. 4 is a schematic cross-sectional view showing the relationship between the target object 100 and illumination directions D3 and D4. The section shown in FIG. 3 corresponds to an X-Z section defined by the X-direction and the Z-direction. The section shown in FIG. 4 corresponds to a Y-Z direction defined by the Y-direction and the Z-direction.

As shown in FIG. 3, illumination directions D1 and D2 incline with respect to the attachment face 111. Illumination direction D1 forms angle θ1 with the attachment face 111. Illumination direction D2 forms angle θ2 with the attachment face 111.

As shown in FIG. 4, illumination directions D3 and D4 incline with respect to the attachment face 111. Illumination direction D3 forms angle θ3 with the attachment face 111. Illumination direction D4 forms angle θ4 with the attachment face 111.

This embodiment assumes a case where angles θ1 to θ4 are the same as each other. For example, each of angles θ1 to θ4 is greater than or equal to 60 degrees. However, the configuration is not limited to this example.

The capture direction Dm by the camera 2 is, for example, parallel to the Z-direction. The axes of the holes Ha, Hb, Hc and Hd are also parallel to the Z-direction.

As shown in FIG. 2 to FIG. 4, each component 120 has a first portion 121 and a second portion 122 connected to the first portion 121. Each of the first portion 121 and the second portion 122 has, for example, a columnar shape (or a cylindrical shape).

In the examples of FIG. 3 and FIG. 4, the first portions 121 are entirely fitted into the holes Ha, Hb, Hc and Hd. For example, the lower end portions of the first portions 121 are in contact with the bottom surfaces of the holes Ha, Hb, Hc and Hd. The second portions 122 partly protrude from the holes Ha, Hb, Hc and Hd, respectively.

The attachment device 6 shown in FIG. 1 inserts the components 120 into the holes Ha, Hb, Hc and Hd, respectively. Each of FIG. 2 to FIG. 4 shows a state in which the components 120 are normally inserted into the holes Ha, Hb, Hc and Hd, respectively. However, abnormal attachment in which the components 120 are not normally inserted into the holes Ha, Hb, Hc and Hd could occur.

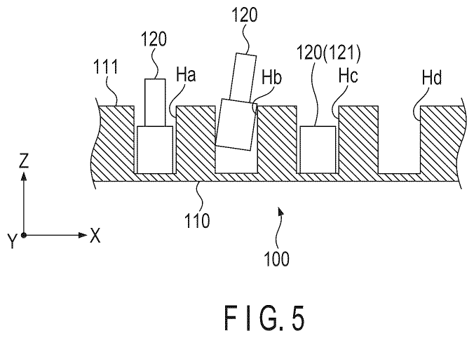

FIG. 5 is a schematic cross-sectional view showing an example of abnormal attachment. The section shown in this figure corresponds to the X-Z section of the target object 100 in a manner similar to that of FIG. 3.

In the example of FIG. 5, the component 120 is normally inserted into the hole Ha. To the contrary, the component 120 is inserted into the hole Hb in a state where the component 120 inclines. In the hole Hc, the second portion 122 is lost from the component 120, and thus, only the first portion 121 is inserted into the hole Hc. Further, no component 120 is inserted into the hole Hd.

The inspection device 1 and inspection method of the embodiment detect this abnormal attachment. This specification shows a specific example of the operation of the inspection device 1 and the inspection method below.

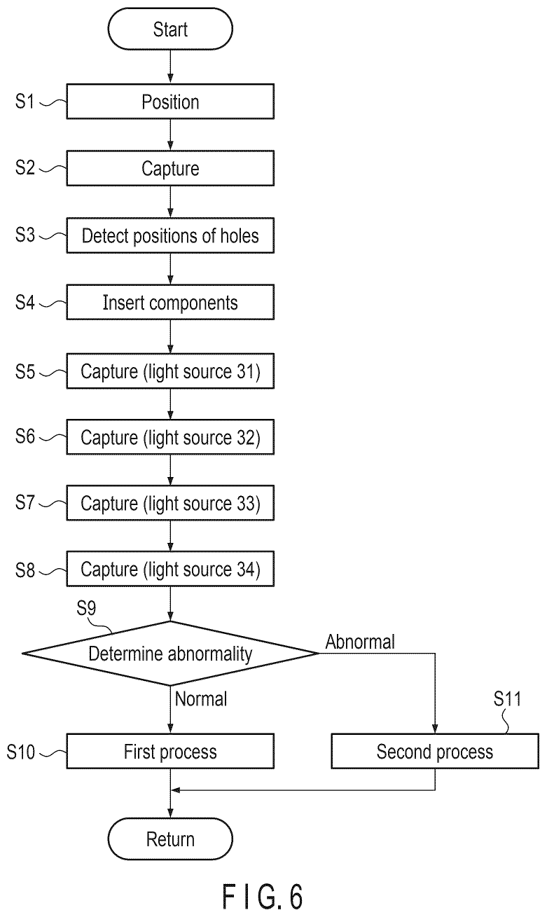

FIG. 6 is a flowchart showing an example of the attachment of the components 120 to the base member 110 and an inspection performed after this attachment. When the components 120 are attached, first, the camera 2, the light sources 31 to 34 and the target object 100 (here, the base member 110 into which no component 120 is inserted) are positioned such that the area A shown in FIG. 2 directly faces the camera 2 (step S1). This operation can be realized when, for example, the movement control module 52 controls the movement mechanism 4 based on digital images generated in series by the camera 2.

After step S1, the camera control module 50 causes the camera 2 to capture the area A (step S2). Further, the analysis module 53 detects the positions of the holes Ha, Hb, Hc and Hd in the digital images obtained by the capturing of step S2 (step S3). The capturing in step S2 may be performed in a state where the light sources 31 to 34 are turned off, or may be performed in a state where at least one of the light sources 31 to 34 is turned on.

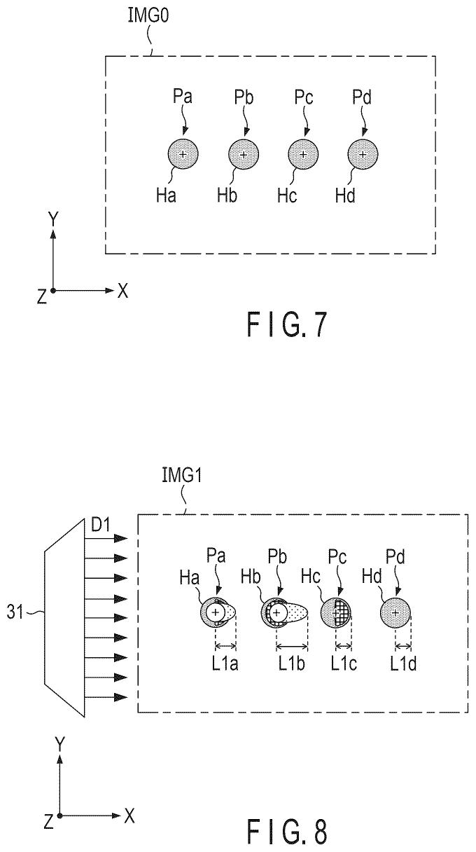

FIG. 7 is a diagram showing an example of digital image IMG0 generated in step S2. For example, digital image IMG0 is a digital image obtained by binarizing a grayscale or color image with multi-gradation generated by the camera 2. Digital image IMG0 includes a shadow portion Pa corresponding to the hole Ha, a shadow portion Pb corresponding to the hole Hb, a shadow portion Pc corresponding to the hole Hc and a shadow portion Pd corresponding to the hole Hd.

In step S3, the analysis module 53 detects, for example, the center (in the figure, the cross mark) of each of the holes Ha, Hb, Hc and Hd as the positions of the holes Ha, Hb, Hc and Hd. The centers of the holes Ha, Hb, Hc and Hd can be detected by, for example, performing an approximation of the outer shape of each of the shadow portions Pa, Pb, Pc and Pd to a precise circle, and calculating the coordinates of their centers.

After step S3, the components 120 are inserted into the holes Ha, Hb, Hc and Hd, respectively, by the attachment device 6 (step S4). For this insertion of the components 120, the coordinates of the centers of the holes Ha, Hb, Hc and Hd detected in step S3 can be used. The attachment device 6 inserts the components 120 into the holes Ha, Hb, Hc and Hd parallelly to the Z-direction such that the centers of the holes Ha, Hb, Hc and Hd are coincident with the centers of the components 120.

After step S4, the light source control module 51 turns on the light source 31, and the camera control module 50 causes the camera 2 to capture the area A (step S5). At the time of this capturing, the other light sources 32, 33 and 34 are turned off.

After step S5, the light source control module 51 turns on the light source 32, and the camera control module 50 causes the camera 2 to capture the area A (step S6). At the time of this capturing, the other light sources 31, 33 and 34 are turned off.

After step S6, the light source control module 51 turns on the light source 33, and the camera control module 50 causes the camera 2 to capture the area A (step S7). At the time of this capturing, the other light sources 31, 32 and 34 are turned off.

After step S7, the light source control module 51 turns on the light source 34, and the camera control module 50 causes the camera 2 to capture the area A (step S8). At the time of this capturing, the other light sources 31, 32 and 33 are turned off.

Subsequently, the analysis module 53 determines whether or not the components 120 are normally inserted into the holes Ha, Hb, Hc and Hd based on the digital images obtained by the capturing in steps S5 to S8 (step S9).

When the components 120 are normally inserted into all of the holes Ha, Hb, Hc and Hd as a result of the determination of step S9 (“normal” in step S9), a first process is performed (step S10). When the components 120 are not normally inserted into at least one of the holes Ha, Hb, Hc and Hd (“abnormal” in step S9), a second process is performed (step S11). A series of operations is terminated by step S10 or step S11.

For example, the first process could include the process of notifying the operator that the attachment of the components 120 has been normally completed. Further, the first process may include the process of recording the normal completion of the attachment of the components 120 in a database.

Similarly, the second process could include the process of notifying the operator that an abnormality has occurred in the attachment of the components 120. Further, the second process may include the process of recording the occurrence of the abnormality in the attachment of the components 120 in the database. Moreover, the second process may include a process for eliminating the abnormality as described later.

Here, this specification explains a specific example of a method for determining an abnormality in step S9.

FIG. 8 to FIG. 11 are diagrams showing examples of digital images IMG1 to IMG4 generated by the camera 2 in steps S5 to $8, respectively. Although abnormal insertion rarely occurs in practice, here, for example, this specification assumes a case where abnormal insertion occurs in the holes Hb, Hc and Hd in the state shown in FIG. 5.

For example, digital images IMG1 to IMG4 are digital images obtained by binarizing grayscale or color images with multi-gradation generated by the camera 2. In a manner similar to that of digital image IMG0 shown in FIG. 7, digital images IMG1 to IMG4 include shadow portions P (Pa, Pb, Pc and Pd) corresponding to the holes Ha, Hb, Hc and Hd. The cross marks in digital images IMG1 to IMG4 are the centers of the holes Ha, Hb, Hc and Hd detected in step S3. In FIG. 8 to FIG. 11, for convenience sake, portions which become black portions by binarization in the shadow portions Pa, Pb, Pc and Pd are shown by hatching.

In digital images IMG1 to IMG4, the shadow of the component 120 (the dotted portion) is generated around the hole Ha into which the component 120 is normally inserted. Similarly, the shadow of the component 120 is generated around the hole Hb in which the component 120 protrudes to the upper side although the insertions is insufficient. The shadow portions Pa and Pb include these shadows of the components 120 in addition to the shadows of the holes Ha and Hb.

Illumination directions D1 to D4 of the light sources 31 to 34 are directions which are different from each other. Thus, the directions in which the shadows of the components 120 are generated around the holes Ha and Hb differ depending on digital images IMG1 to IMG4. Therefore, the shapes of the shadow portions Pa and Pb also differ depending on digital images IMG1 to IMG4.

The shadow portion Pd of the hole Hd into which no component 120 is inserted is a circular shadow which is dark as a whole in all of digital images IMG1 to IMG4. The shadow portion Pc of the hole Hc in which the second portion 122 is lost and into which only the first portion 121 is inserted is also a circular shadow in each of digital images IMG1 to IMG4. However, as light is slightly reflected on the first portion 121 inside the hole Hc, a portion which is slightly brighter than the shadow portion Pd (in other words, a portion converted to white by binarization) could be generated in the shadow portion Pc.

The analysis module 53 measures length L1 (L1a, L1b, L1c and L1d) with respect to each of the shadow portions Pa, Pb, Pc and Pd of digital image IMG1 shown in FIG. 8. Length L1a corresponds to the distance from the center of the hole Ha to the end portion of the shadow portion Pa in illumination direction D1 (in FIG. 8, the X-direction). Length L1b corresponds to the distance from the center of the hole Hb to the end portion of the shadow portion Pb in illumination direction D1. Length L1c corresponds to the distance from the center of the hole Hc to the end portion of the shadow portion Pc in illumination direction D1. Length L1d corresponds to the distance from the center of the hole Hd to the end portion of the shadow portion Pd in illumination direction D1.

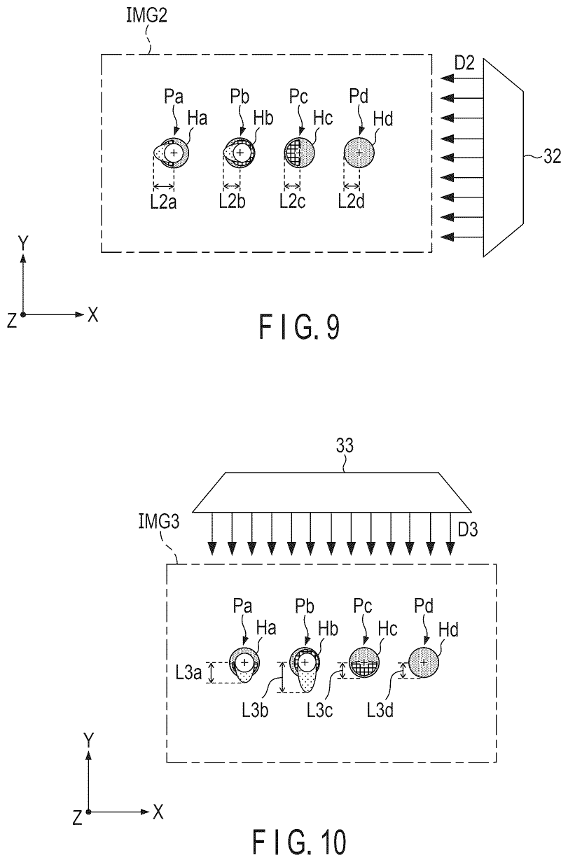

The analysis module 53 measures length L2 (L2a, L2b, L2c and L2d) with respect to each of the shadow portions Pa, Pb, Pc and Pd of digital image IMG2 shown in FIG. 9. Length L2a corresponds to the distance from the center of the hole Ha to the end portion of the shadow portion Pa in illumination direction D2 (in FIG. 9, a direction opposite to the X-direction). Length L2b corresponds to the distance from the center of the hole Hb to the end portion of the shadow portion Pb in illumination direction D2. Length L2c corresponds to the distance from the center of the hole Hc to the end portion of the shadow portion Pc in illumination direction D2. Length L2d corresponds to the distance from the center of the hole Hd to the end portion of the shadow portion Pd in illumination direction D2.

The analysis module 53 measures length L3 (L3a, L3b, L3c and L3d) with respect to each of the shadow portions Pa, Pb, Pc and Pd of digital image IMG3 shown in FIG. 10. Length L3a corresponds to the distance from the center of the hole Ha to the end portion of the shadow portion Pa in illumination direction D3 (in FIG. 10, a direction opposite to the Y-direction). Length L3b corresponds to the distance from the center of the hole Hb to the end portion of the shadow portion Pb in illumination direction D3. Length L3c corresponds to the distance from the center of the hole Hc to the end portion of the shadow portion Pc in illumination direction D3. Length L3d corresponds to the distance from the center of the hole Hd to the end portion of the shadow portion Pd in illumination direction D3.

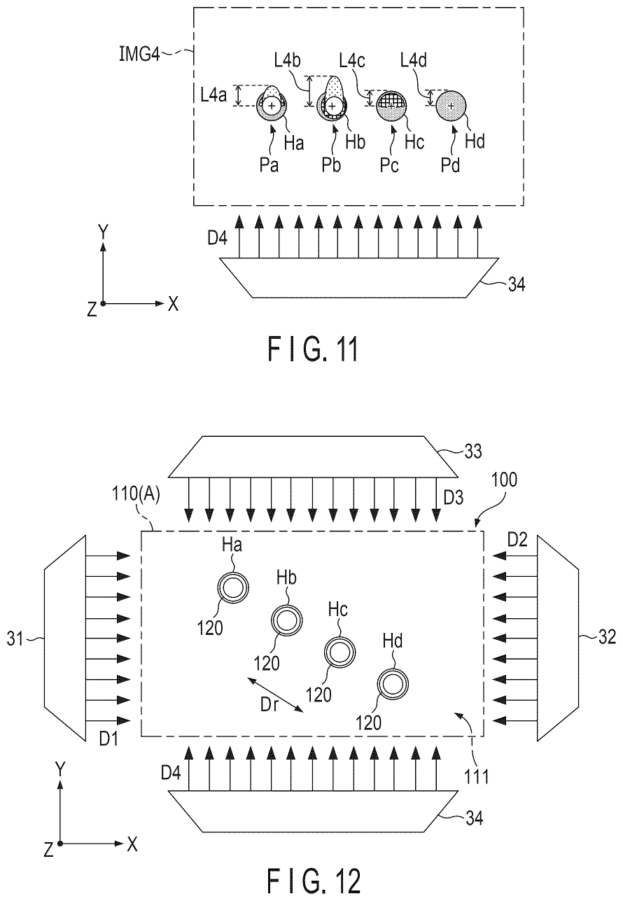

The analysis module 53 measures length L4 (L4a, L4b, L4c and L4d) with respect to each of the shadow portions Pa, Pb, Pc and Pd of digital image IMG4 shown in FIG. 11. Length L4a corresponds to the distance from the center of the hole Ha to the end portion of the shadow portion Pa in illumination direction D4 (in FIG. 10, the Y-direction). Length L4b corresponds to the distance from the center of the hole Hb to the end portion of the shadow portion Pb in illumination direction D4. Length L4c corresponds to the distance from the center of the hole Hc to the end portion of the shadow portion Pc in illumination direction D4. Length L4d corresponds to the distance from the center of the hole Hd to the end portion of the shadow portion Pd in illumination direction D4.

In the examples of FIG. 8 to FIG. 11, lengths L1a to L4a correspond to the lengths of the shadows of the component 120 inserted into the hole Ha. Lengths L1b to L4b correspond to the lengths of the shadows of the component 120 inserted into the hole Hb.

In the embodiment, the analysis module 53 determines whether or not the insertion of the components 120 into the holes H is normal based on at least length L1, length L2, length L3 and length L4.

The abnormality determined by the analysis module 53 includes, for example, the following NG modes.

NG mode 1: A state in which the component 120 is not inserted into the hole H.

NG mode 2: A state in which the component 120 slightly protrudes from the hole H straight relative to the normal state.

NG mode 3: A state in which the component 120 considerably protrudes from the hole H straight relative to the normal state.

NG mode 4: A state in which the component 120 slightly protrudes from the hole H at a slant relative to the normal state.

NG mode 5: A state in which the component 120 considerably protrudes from the hole H at a slant relative to the normal state.

NG mode 6: A state in which an incomplete component 120 from which the second portion 122 is lost is inserted into the hole H.

This specification explains an example of the determination method of NG modes 1 to 6.

In each of NG modes 1 and 6, lengths L1 to L4 are equal to the radius of the hole H. To determine NG modes 1 and 6, the analysis module 53 determines whether or not all of lengths L1 to L4 are less than or equal to threshold SH1. This threshold SH1 is set so as to be a value for determining that the component 120 is not inserted into the hole H, for example, a value which is slightly greater than the radius of the hole H.

When all of lengths L1 to L4 are less than or equal to threshold SH1, the analysis module 53 also refers to the shadow portion P of the hole H in digital images IMG1 to IMG4. For example, when a portion corresponding to the hole H is entirely dark as in the case of the shadow Pd of FIG. 8 to FIG. 11, it is considered that no component 120 is inserted into the hole H. Thus, the state can be determined as NG mode 1. When a portion corresponding to the hole H includes an area which is slightly bright as in the case of the shadow Pc, it is considered that an incomplete component 120 is inserted into the hole H. Thus, the state can be determined as NG mode 6.

In all of NG modes 2 to 5, the insertion of the component 120 into the hole H is incomplete. To determine NG modes 2 to 5, the analysis module 53 determines whether or not the difference in lengths L1 to L4 (the difference in the length of the shadow of the component 120) is greater than or equal to threshold SH2. As the difference described here, for example, the difference between the maximum value and the minimum value in lengths L1 to L4 can be used. For example, when the component 120 is inserted into the hole H straight, as lengths L1 to L4 are substantially equal to each other, the above difference is substantially zero. When the component 120 is inserted into the hole H at a slant, at least some of lengths L1 to L4 differ from each other, and thus, the above difference is not zero. Threshold SH2 differentiates the state in which the component 120 is inserted at a slant in this manner from the state in which the component 120 is inserted straight.

Further, the analysis module 53 determines whether or not lengths L1 to L4 are greater than or equal to threshold SH3. Threshold SH3 differentiates the state in which the component 120 is normally inserted as in the case of the hole Ha shown in FIG. 5 from the state in which the component 120 is floating relative to the bottom of the hole H.

Further, when lengths L1 to L4 are greater than or equal to SH3, the analysis module 53 determines whether or not lengths L1 to L4 are greater than or equal to threshold SH4. Threshold SH4 is greater than threshold SH3 and differentiates the state in which the component 120 slightly protrudes relative to the normal state from the state in which the component 120 considerably protrudes. For the comparison between thresholds SH3 and SH4, for example, the maximum values, minimum values or mean values of lengths L1 to L4 could be used.

When, as a result of the above determination, the difference in lengths L1 to L4 is less than threshold SH2, and lengths L1 to L4 are greater than or equal to threshold SH3 and further less than threshold SH4, the state can be determined as NG mode 2. When the difference in lengths L1 to L4 is less than threshold SH2, and lengths L1 to L4 are greater than or equal to threshold SH4, the state can be determined as NG mode 3. When the difference in lengths L1 to L4 is greater than or equal to threshold SH2, and lengths L1 to L4 are greater than or equal to threshold SH3 and further less than threshold SH4, the state can be determined as NG mode 4. When the difference in lengths L1 to L4 is greater than or equal to threshold SH2, and lengths L1 to L4 are greater than or equal to threshold SH4, the state can be determined as NG mode 5.

In step S9, from NG modes 1 to 6, to which mode each of the holes Ha, Hb, Hc and Hd is applicable is determined by the method described above. In the example of FIG. 5 and FIG. 8 to FIG. 11, the hole Hb is determined as one of NG modes 4 and 5, and the hole Hc is determined as NG mode 6, and the hole Hd is determined as NG mode 1. Since the hole Ha is not applicable to any of NG modes 1 to 6, the analysis module 53 determines that the component 120 is normally attached.

As stated above, the second process in step S11 could include a process for eliminating abnormality. For example, when the abnormality of NG mode 1 occurs, the attachment device 6 may retry the insertion of the component 120 into the hole H in which this abnormality occurs.

When the abnormality of NG modes 2 to 4 occurs, the process of pressing the component 120 into the hole H in which this abnormality occurs may be performed. This process may be performed by the attachment device 6 or may be performed by another device or may be performed manually.

When the abnormality of NG modes 2 to 4 and 5 occurs, a screen indicating the hole H having this abnormality may be shown in the display etc., of the controller 5. It is preferable that this screen is displayed so as to, for example, allow the operator to visually determine, of the holes Ha, Hb, Hc and Hd, in which hole this abnormality occurs. The screen may include a message which prompts the operator to manually correct the abnormality.

When the abnormality of NG modes 2 to 6 occurs, the component 120 may be removed from the hole H in which the abnormality occurs. This process may be performed by the attachment device 6 or may be performed by another device or may be performed manually. After the component 120 is removed in this manner, the process may return to step S4 such that the component 120 is inserted into the hole H again, and the process of and after step S5 may be performed again.

In the embodiment described above, to inspect the target object 100, the light sources 31 to 34 are turned on in series, and the area A including the holes H (Ha, Hb, Hc and Hd) is captured by the camera 2. Further, whether or not the components 120 are normally inserted into the holes H is determined based on the shadow portions P (Pa, Pb, Pc and Pd) included in digital images IMG1 to IMG4 generated by this capturing.

By this configuration, the detection accuracy of abnormalities can be increased compared to the case of determination based on an image obtained by unidirectional illumination. Specifically, it is difficult to detect a state in which the component 120 is inserted at a slant as in the case of NG modes 4 and 5 even on the basis of only the shadow portion in an image obtained by unidirectional illumination. Specifically, in a case where the component 120 inclines so as to face to the direction of the light source, even if the component 120 protrudes from the hole H relative to the normal state, there is a possibility that a shadow portion having the same shape as the normal state is generated. In this case, even if the component 120 inclines, the state might be determined as the normal state.

To the contrary, in a case where a plurality of digital images IMG1 to IMG4 captured by illuminating the target object in different directions are used like the embodiment, abnormalities such as NG modes 4 and 5 can be also detected.

Further, in the embodiment, whether or not the component 120 is inserted into the hole H in a state where the first portion 121 and second portion 122 of the component 120 are normally connected to each other (in other words, a state which is not applicable to NG mode 6) is also determined. This configuration allows an inspection which considers the abnormality of the component 120 itself consisting of a plurality of parts as well.

The configuration disclosed in the embodiment can be modified in various ways. For example, the relationships between the light sources 31 to 34 and the holes Ha, Hb, Hc and Hd are not limited to the example shown in FIG. 2.

FIG. 12 is a schematic plan view showing a modified example of the relationships between the light sources 31 to 34 and the holes Ha, Hb, Hc and Hd. In this modified example, the array direction Dr of the holes Ha, Hb, Hc and Hd intersects with illumination directions D1 to D4 as seen in plan view.

In this configuration, the shadow of a component 120 generated at the time of turning on each of the light sources 31 to 34 does not easily overlap another hole H located near the hole H into which the component 120 is inserted. Thus, the accuracy of detecting abnormalities can be further increased.

The inspection device 1 does not necessarily comprise four light sources 31 to 34. For example, if the detection device 1 comprises at least two light sources, a state in which the component 120 inclines as in the case of NG modes 4 and 5 can be detected based on the length of the shadow of the component 120.

The embodiment assumes a case where each component 120 comprises the cylindrical first portion 121 and the cylindrical second portion 122. However, the configuration of each component 120 is not limited to this example. Each component 120 may include three or more portions which can be separated from each other. Further, each portion of each component 120 may have another shape such as a block shape. Alternatively, each component 120 may be a component which cannot be disassembled. In addition, the shape of each hole H is not limited to the examples shown in the drawings.

The target object 100 for the inspection is not particularly limited. The inspection device 1 and inspection method disclosed in the embodiment can be widely applied to structures in which a component is inserted into a hole.

Illumination directions D1 to D4 of the light sources 31 to 34 do not necessarily incline at the same angle with respect to the attachment face 111. In other words, at least one of angles θ1 to θ4 shown in FIG. 3 and FIG. 4 may be different from the other angles.

Digital images IMG0 to IMG4 are not necessarily images obtained by binarization. For example, the analysis module 53 may detect the positions of the holes Ha, Hb, Hc and Hd based on image IMG0 which is a grayscale or color image with multi-gradation generated by the camera 2 in step S3. Further, the analysis module 53 may detect the shadow portions Pa, Pb, Pc and Pd based on images IMG1 to IMG4 which are grayscale or color images with multi-gradation generated by the camera 2 in step S9.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An inspection device for a target object including a hole and a component inserted into the hole, the device comprising:
a plurality of light sources configured to illuminate an area including the hole in different directions in series;
a camera configured to generate a plurality of digital images of the area illuminated by the light sources in series; and
a controller configured to determine whether the component is normally inserted into the hole based on a shadow included in each of the digital images generated by the camera.

2. The inspection device of claim 1, wherein
the controller is configured to determine whether the component is normally inserted into the hole based on a length of a shadow of the component included in the digital images.

3. The inspection device of claim 2, wherein
the controller is configured to determine whether the component is normally inserted into the hole by comparing a difference in a length of the shadow of the component included in at least two of the digital images with a threshold.

4. The inspection device of claim 1, wherein
the component includes first and second portions which can be separated from each other, and
the controller is further configured to determine whether the component is inserted into the hole in a state where the first portion and the second portion are normally connected to each other based on the digital images.

5. The inspection device of claim 1, wherein
directions in which the respective light sources emit light incline at a same angle with respect to a face on which the hole is provided in the target object.

6. The inspection device of claim 1, wherein
the target object has linearly arranged holes including the hole, and
directions in which the respective light sources emit light intersect with an array direction of the holes as seen in plan view.

7. An inspection method for a target object including a hole and a component inserted into the hole, the method including:
illuminating an area including the hole by a plurality of light sources in different directions in series;
generating a plurality of digital images of the area illuminated by the light sources in series by a camera; and
determining whether the component is normally inserted into the hole based on a shadow included in each of the digital images generated by the camera.

8. The inspection method of claim 7, wherein
the determining includes determining whether the hole is normally inserted into the hole based on a length of a shadow of the component included in each of the digital images.

9. The inspection method of claim 8, wherein
the determining includes determining whether the component is normally inserted into the hole by comparing a difference in a length of the shadow of the component included in at least two of the digital images with a threshold.

10. The inspection method of claim 7, wherein
the component includes first and second portions which can be separated from each other, and
the determining includes determining whether the component is inserted into the hole in a state where the first portion and the second portion are normally connected to each other based on the digital images.

11. The inspection method of claim 7, wherein
directions in which the respective light sources emit light incline at a same angle with respect to a face on which the hole is provided in the target object.

12. The inspection method of claim 7, wherein
the target object has linearly arranged holes including the hole, and
directions in which the respective light sources emit light intersect with an array direction of the holes.
